(19) United States
(12) Patent Application Publication
(10) Pub. No.: US 2010/0320052 A1
(43) Pub. Date: Dec. 23, 2010

(54) SYNCRONISM SYSTEM FOR A VEHICLE POWER TRANSMISSION MECHANISM

(75) Inventors: DIEGO CASTRO, GIJON (ES); JUAN IGNACIO LOPEZ MARTINEZ, OVIEDO (ES); YVAN PRESA, OVIEDO (ES); JORGE VILLARRICA VINES, VILLAVICIOSA (ES)

Correspondence Address: LERNER GREENBERG STEMER LLP, P O BOX 2480, HOLLYWOOD, FL, 33022-2480, US

(73) Assignee: PMG ASTURIAS POWDER METAL S.A.U., MIERES (ES)

(21) Appl. No.: 12/869,240

(22) Filed: Aug. 26, 2010

Related U.S. Application Data
(63) Continuation of application No. PCT/EP2009/001421, filed on Feb. 27, 2009.

(30) Foreign Application Priority Data
Feb. 28, 2008 (ES) P200800579

(51) Int. Cl. F16D 23/00

(52) U.S. Cl. 192/114 R

(57) ABSTRACT

A synchronism system for a vehicle power transmission mechanism, of the type which makes an elastic connection between a sliding clutch sleeve and a synchronizer hub of the power transmission mechanism. A locking device is formed by at least one casing, which houses therein at least one elastic element. The casing contacts with the synchronizer hub being disposed in a housing made in the periphery thereof, and the elastic element is a torsion spring which exerts tension between the clutch sleeve and the synchronizer hub.

### CROSS-REFERENCE TO RELATED APPLICATION

This is a continuation application, under 35 U.S.C. §120, of copending international application No. PCT/EP2009/001421, filed Feb. 27, 2009, which designated the United States; this application also claims the priority, under 35 U.S.C. §119, of Spanish patent application No. P 200800579, filed Feb. 28, 2008; the prior applications are herewith incorporated by reference in their entirety.

### TECHNICAL FIELD OF THE INVENTION

The present invention relates to the field of auxiliary components in the motor vehicle sector and, more specifically, to synchronism systems for vehicle power transmission mechanisms. The object relates to a synchronization system based on a locking device with at least one elastic element.

### BACKGROUND OF THE INVENTION

### Field of the Invention

The motor vehicle market quickly evolves setting increasingly ambitious challenges as regards the features the components forming a motor vehicle should perform.

At present, power transmission mechanisms, such as gear boxes, reducers, etc., are equipped with synchronization systems that ensure greater reliability and performance of the gear changes. The function of synchronizations systems is to permit that, on the same power shaft, two gears, one solidly joined to the shaft and another idle with different rotation speeds, equal their rotation speeds to allow the gear change by a sliding sleeve and drag rings.

In operation, the sliding sleeve advances with axial movement towards the movement gear. The synchronizer hub, which is rigidly joined to the power shaft, rotates with the same rotation speed as the latter, guides and transmits the rotation speed to the sliding sleeve during its axial movement. Throughout the process, the sliding sleeve comes into contact with the drag ring and advances axially towards the movement gear. One of the most important elements in the synchronization process is the locking device, a functional element that facilitates the guiding of the sliding sleeve being solidly joined thereto until meeting with the drag ring.

The locking device is generally composed of an elastic element, a positioning element and a casing which retains the elastic element and the positioning element. The casing is for example housed in a groove made in the outer toothing of the synchronizer hub and which penetrates one measure towards the center of the piece. The positioning element contacts with the sleeve, being housed in a striation thereof. The elastic element rests on the casing and, if applicable, against the positioning element maintaining a certain tension between them, and achieving the contact between the synchronizer hub and the clutch sleeve. This means that until the force of the elastic element is not overcome, the locking element and the sleeve remain solidly joined. Most locking elements currently used are based on a linear compression spring as an elastic element housed in a T-shaped seat, which has a sphere in its upper part as the positioning element. This type of device has drawbacks related to the high depth that the seats that house the current locking devices need, which causes a decrease in mechanical resistance of the synchronization hub in the radial direction.

This type of lockings based on compression springs are found in published German patent/application Nos. DE10 2005 054 743, DE 10 2005 061 481, DE 10 2005 061 977, DE 102 55 802, published European patent application EP 1 310 693 and U.S. Pat. No. 5,862,900.

There currently exists another type of device, based on elastic elements different to compression springs. One of them is described in international patent application WO 03/104670, based on a retention element which consists of an arc-type spring with elastic properties located in the interior of a support element and with a cover finished with an element in the form of a sphere. Similar is the device disclosed in French patent application FR 2 785 026, wherein the element with the form of a sphere has been replaced by a continuity of the actual elastic element. These systems also cause a high need for space for the housing of the elastic element and the sphere, if applicable.

A system is therefore desirable that achieves a suitable contact between the synchronizer hub and the clutch sleeve of a synchronism system of power transmission mechanisms, avoiding the drawbacks existing in the previous systems of the state of the art.

### SUMMARY OF THE INVENTION

It is accordingly an object of the invention to provide a synchronism system for a vehicle power transmission mechanism which overcomes the above-mentioned disadvantages of the prior art devices of this general type, which provides an elastic connection between a sliding clutch sleeve of a power transmission mechanism and a synchronizer hub of the power transmission mechanism. The locking device has the function of a strut.

With the foregoing and other objects in view there is provided, in accordance with the invention a synchronism system for a vehicle power transmission mechanism. The synchronism system contains a locking device having at least one elastic element and a casing for housing therein the at least one elastic element. The locking device contacts elastically with a sliding clutch sleeve of the power transmission mechanism and a synchronizer hub of the power transmission mechanism. The at least one elastic element is a torsion spring, exerting tension towards the sliding clutch sleeve and towards the synchronizer hub.

The locking device contains at least one casing which has at least one elastic element therein. The at least one casing is disposed preferably in a housing made in the synchronizer hub. Preferably, the casing is movable relative to the synchronizer hub and to the clutch sleeve.

In another preferred embodiment and for a specific application of the locking device, the at least one casing is created at least partly by the synchronizer hub, i.e. the at least one casing is part of the synchronizer hub itself.

The elastic element is a torsion spring with a spring axis. The spring force exerts tension between the clutch sleeve and the synchronizer hub. This type and geometry of a torsion spring allows a low depth of the locking device. Consequently, mechanical resistance of the synchronizer hub is increased, in particular in the radial direction.

Preferably, the spring force is directed generally in a transverse direction relative to the spring axis. The torsion spring acts in the manner like a leg spring. Preferably, the torsion spring is movable relative to the synchronizer hub and/or to the clutch sleeve along the radial direction of the synchronizer hub and the clutch sleeve.

According to different embodiments of the invention, and depending on specific requirements, there may be more than one locking device (for example three locking devices) each with at least a torsion spring to make the contact. Preferably, the locking devices are disposed uniformly throughout the periphery of the synchronizer hub.

Preferably, the locking device also has a positioning element housed in the casing and which is in contact with the torsion spring, contacting with the clutch sleeve, so that the torsion spring exerts the tension on the clutch sleeve through the positioning element.

In this regard, the torsion spring exerts the tension through the casing, if there exists a separate casing housed in the synchronizer hub. Otherwise, if the casing is part of the synchronizer hub, torsion spring exerts the tension directly on the synchronizer hub.

The embodiment of a locking device with a positioning element has the advantage of providing greater contact, and therefore, a more uniform tension, in addition to avoiding the friction of the torsion spring against the clutch sleeve, which would cause the deterioration of both elements.

The positioning element may comprise parts with different geometries such as a plate with a protuberance, or a semi-spherical, cylindrical or semi-cylindrical body.

For example, the locking device may contain a positioning sphere as a positioning element which is housed in the casing partially protruding therefrom, so that the torsion spring exerts the tension on the clutch sleeve through the positioning sphere.

In accordance with a particular embodiment of the invention, the torsion spring can be formed by a single body of helicoidal winding and a pair of end arms of this winding body. According to one embodiment, the body either exerts tension towards the clutch sleeve by resting on the two end arms that exert tension towards the synchronizer hub or the body can rest on a seat made in the casing, while one of the arms exerts tension towards the synchronizer hub and the other exerts tension towards the clutch sleeve.

According to an alternative embodiment of the invention, the torsion spring has two helicoidal winding bodies joined by a central joining portion, and an end arm at each one of the winding bodies. In this case, the central joining portion exerts tension towards the clutch sleeve and the end arms towards the synchronizer hub or, according to an opposite disposal of the torsion spring, the central joining portion exerts tension towards the synchronizer hub while the end arms exert tension towards the clutch sleeve. For realizing these alternatives, the central joining portion and the end arms are preferably positioned at the same radial side relative to the spring axis of the torsion spring.

In another preferred embodiment, the central joining portion and/or the end arms exert tension towards either the synchronizer hub or the clutch sleeve, while the helicoidal winding bodies exert tension towards either the clutch sleeve or the synchronizer hub. For realizing these alternatives, the central joining portion and the end arms are preferably positioned at opposite radial sides relative to the spring axis of the torsion spring.

Other features which are considered as characteristic for the invention are set forth in the appended claims.

Although the invention is illustrated and described herein as embodied in a synchronism system for a vehicle power transmission mechanism, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### DESCRIPTION OF THE FIGURES

FIG. 1 is a diagrammatic, perspective view of a power transmission system showing a synchronizer hub, a clutch sleeve being separated from one another, and a locking device according to the invention;

FIG. 2 is a perspective view of the same power transmission system and the locking device of FIG. 1, wherein the synchronizer hub and the clutch sleeve are connected by the locking device disposed between them;

FIG. 3A is a diagrammatic, perspective view of a first embodiment of the locking device of the invention in a mounted position;

FIG. 3B is a diagrammatic, exploded perspective view of the first embodiment of the locking device of the invention in a dismantled position;

FIG. 4A is a diagrammatic, perspective view of a second embodiment of the locking device of the invention in a mounted position;

FIG. 4B is a diagrammatic, exploded perspective view of the second embodiment of the locking device of the invention in a dismantled position;

FIG. 5A is a diagrammatic, perspective view of a third embodiment of the locking device of the invention in a mounted position;

FIG. 5B is a diagrammatic, exploded perspective view of the third embodiment of the locking device of the invention in a dismantled position;

FIG. 6A is a diagrammatic, perspective view of a fourth embodiment of the locking device of the invention in a mounted position;

FIG. 6B is a diagrammatic, exploded perspective view of the fourth embodiment of the locking device of the invention in a dismantled position;

FIG. 7A is a diagrammatic, perspective view of a fifth embodiment of the locking device of the invention in a mounted position;

FIG. 7B is a diagrammatic, exploded perspective view of the fifth embodiment of the locking device of the invention in a dismantled position;

FIG. 8A is a diagrammatic, perspective view of a sixth embodiment of the locking device of the invention in a mounted position;

FIG. 8B is a diagrammatic, exploded perspective view of a sixth embodiment of the locking device of the invention in a dismantled position;

FIG. 9 is a diagrammatic, exploded perspective view of a seventh embodiment of the locking device of the invention in dismantled position; and

FIG. 10 is a diagrammatic, perspective view of an eighth embodiment of the locking device according to the invention.

### DESCRIPTION OF PREFERRED EMBODIMENTS OF THE INVENTION

The object of the invention is a synchronism system for vehicle power transmission mechanisms.

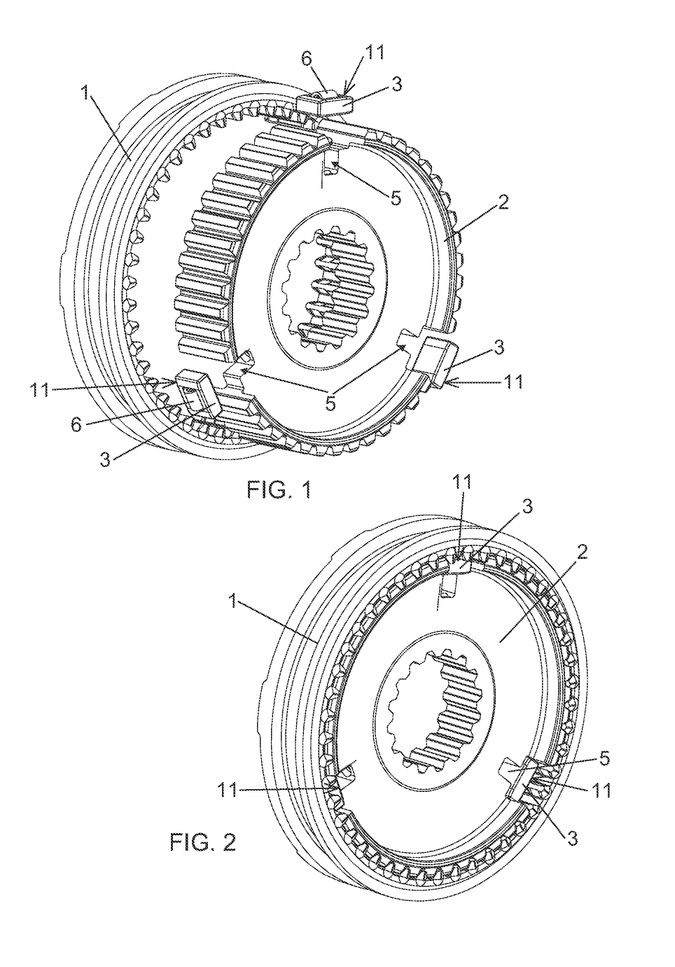

Referring now to the figures of the drawing in detail and first, particularly, to FIGS. 1 and 2 thereof, there is shown the arrangement of a locking device 11 in a vehicle power transmission mechanism, the locking device 11 making the elastic contact between a sliding clutch sleeve 1 of the power transmission mechanism and a synchronizer hub 2 of said power transmission mechanism.

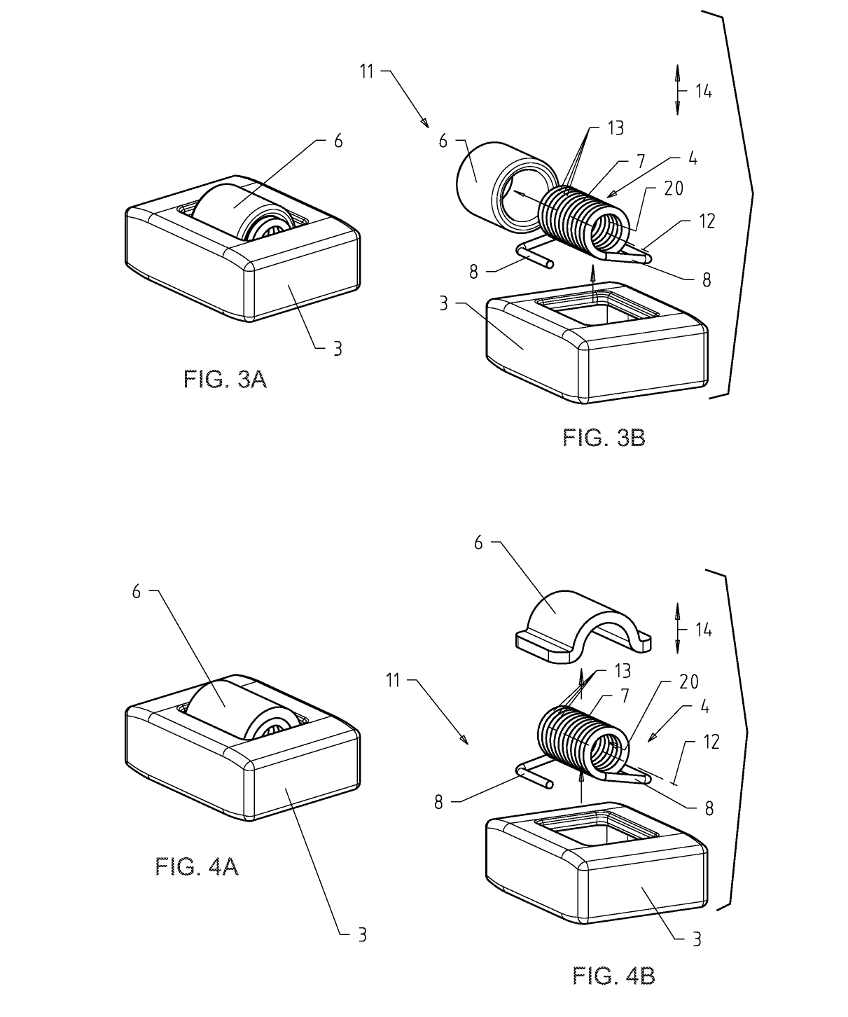

As can be observed in FIGS. 1 and 2, and in greater detail in particular embodiments of FIGS. 3A to 10, the locking device has at least one casing 3, which houses therein at least one elastic element 4. The casing 3 is created separately from the synchronizer hub 2.

The casing 3 contacts with the synchronizer hub 2 being disposed in a housing 5 made for the purpose in the radial periphery of the synchronizer hub 2. On the other hand, the elastic element 4 is a torsion spring 4, which exerts tension on the clutch sleeve 1 and on the synchronizer hub 2. The torsion spring 4 has a spring axis 12. The spring axis 12 is consistent with a central axis of a winding body 7, which contains several coils 13. The spring force generating mechanical tension towards the clutch sleeve 1 and the synchronizer hub 2 is directed in a transverse direction 14 relative to the spring axis 12.

According to a preferred embodiment of the invention, the torsion spring 4 directly contacts with the clutch sleeve 1 exerting tension towards it.

In an alternative embodiment, in addition to the casing 3 and the torsion spring 4, the locking device 11 has a positioning element 6 which is in contact with the torsion spring 4 and is that which contacts with the clutch sleeve 1. In this way, the torsion spring 4 exerts tension on the synchronizer hub 2 through the casing 3, and on the clutch sleeve 1 through the positioning element 6 achieving a more uniform contact, and therefore a more uniform transmission of tension, in addition to avoiding the friction between the torsion spring 4 and the clutch sleeve 1 which caused the scratching and deterioration of both, obtaining a greater durability of the components.

FIGS. 3A to 10 show different embodiments of the invention depending on different embodiments of this positioning element 6 and the torsion spring 4.

In a particular embodiment of the invention, the positioning element 6 contains a plate with a protuberance which partially protrudes from the casing 3 and it is what makes the contact with the clutch sleeve 1 (see FIGS. 4A, 4B).

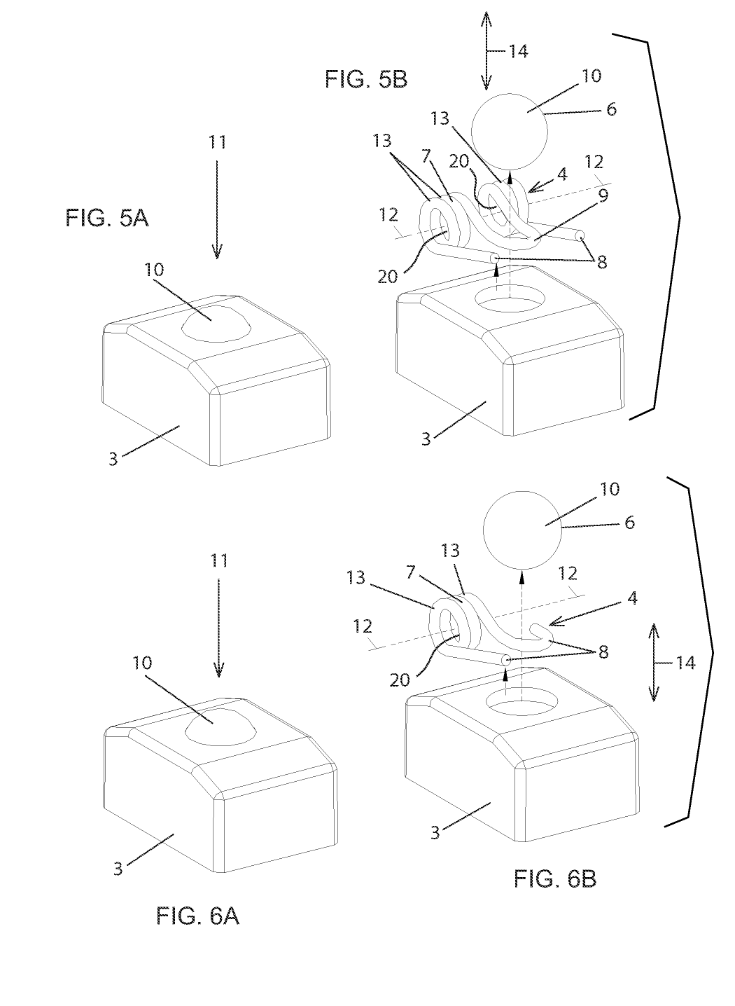

In another alternative embodiment, represented in FIGS. 5A, 5B, 6A and 6B, the positioning element 6 contains a positioning sphere 10 which is disposed on the elastic element 4 and is housed in the casing 3 partially protruding therefrom, connecting with the clutch sleeve 1, and being what transmits the tension of the torsion spring 4 to the clutch sleeve 1.

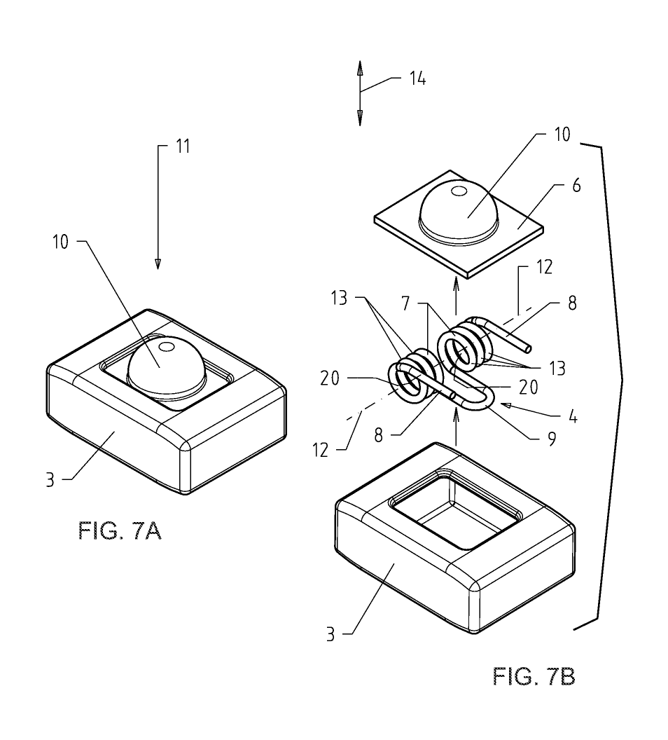

In an alternative embodiment, which is represented in FIGS. 7A, 7B, and is based on a combination of the two previous embodiments, the locking device 11 contains both the plate 6 and the positioning sphere 10, the plate 6 being in contact with the torsion spring 4 and the positioning sphere 10 on the plate 6 in contact with it, and in contact with the clutch sleeve 1 whereto it transmits the tension received from the plate 6 which also receives the torsion spring 4. The positioning sphere 10 is preferably securely fixed at the plate 6.

In accordance with a different embodiment to the previous ones, the positioning element 6 contains a cavity which houses at least part of the torsion spring 4, housing the positioning element 6 in the casing 3 and protruding at least partially therefrom (see FIGS. 3A, 3B).

According to this embodiment, the positioning element 6 which contains the cavity may have a semi-spherical, cylindrical geometry, such as that represented in FIGS. 3A, 3B, or semi-cylindrical, such as that represented in FIGS. 4A, 4B or any other geometry that provides a suitable contact between the synchronizer hub and the sliding sleeve.

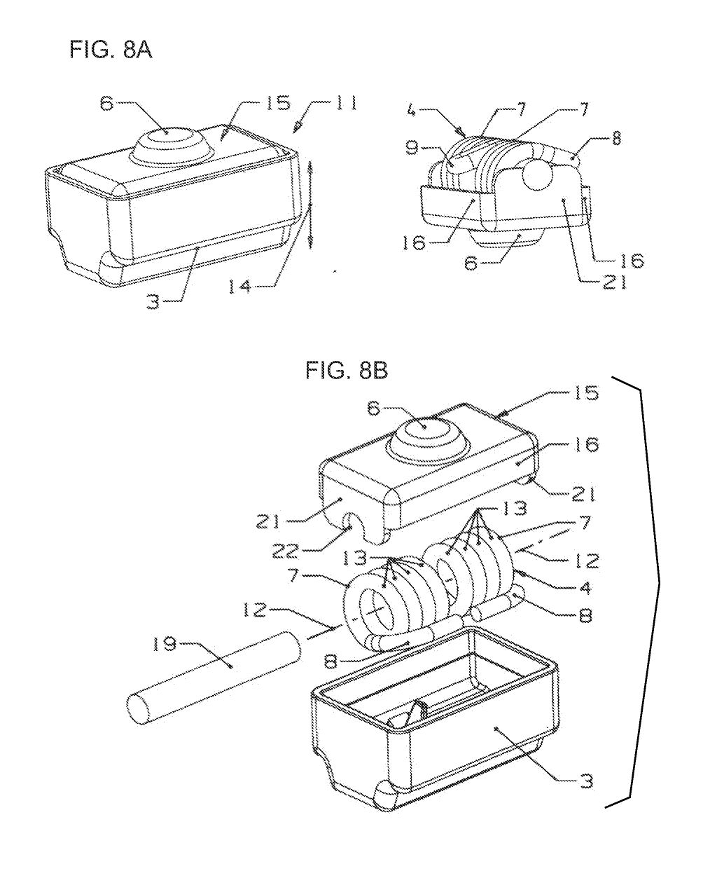

According to another embodiment, the positioning element 6 is arranged at the outer side of a cap 15, which is movable arranged in the casing 3 (see FIGS. 8A, 8B). The movements of the cap 15 are directed in transverse direction 14 and stabilized by side walls 16, which act as guiding areas for the cap 15, in this connection corresponding with the respective inner walls of the casing 3.

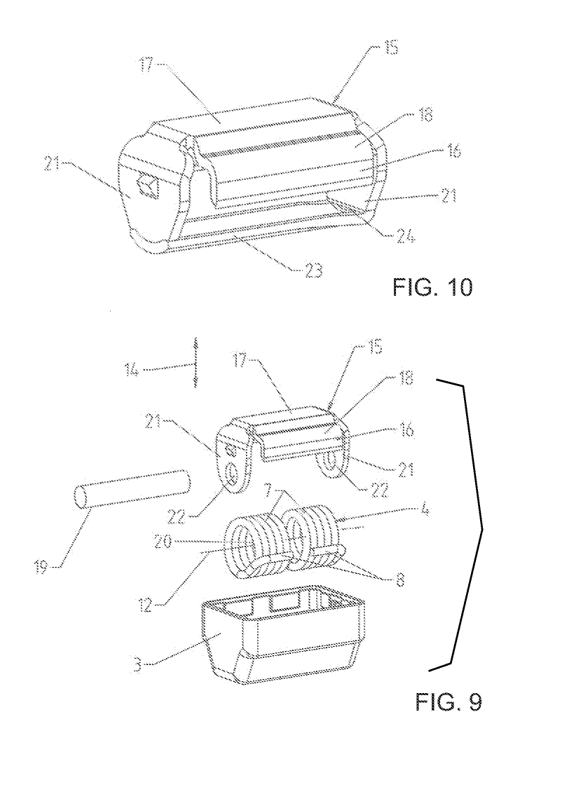

According to another embodiment of the cap 15, the positioning element 6 is created by a flat surface zone 17 of the cap 15 itself (see FIGS. 9, 10). In FIGS. 9 and 10, the side walls 16 are joined by bowed sections 18 with a surface zone 17. In an alternative embodiment, there is arranged a separately positioning element at the surface zone 17, for example shaped in a manner like in the FIGS. 3A-8B.

As regards the torsion spring 4, according to the form thereof there are different embodiments of the invention.

According to a particular embodiment of the torsion spring 4, it is formed by a single helicoidal winding body 7 and a pair of end arms 8 of this helicoidal winding body 7.

FIGS. 3A, 3B, 4A and 4B represent this embodiment of the torsion spring 4, wherein it is the helicoidal winding body 7 that which exerts tension towards the clutch sleeve 1, resting on the pair of arms 8 that exert tension towards the synchronizer hub 2.

In contrast, according to an alternative particular embodiment of this invention, not represented in the figures, the helicoidal winding body 7 is disposed on a seat of the casing 3 and one of the arms 8 exerts tension towards the clutch sleeve and the other arm 8 in the opposite direction, towards the synchronizer hub 2.

There are further different configurations of the torsion spring 4, which are shown in FIGS. 5A, 5B, 7A, 7B, 8A, 8B, 9, wherein this torsion spring has two helicoidal winding bodies 7, joined together by a central joining portion 9, and an end arm 8 at each one of the helicoidal winding bodies 7.

Several alternative versions of this configuration may exist. In one of them, the central joining portion 9 exerts tension towards the clutch sleeve 1, while the arms 8 exert tension towards the synchronizer hub 2 (see FIGS. 5A, 5B). In contrast, in another alternative, the central joining portion 9 exerts tension towards the synchronizer hub 2 and the arms 8 exert tension towards the clutch sleeve 1 (see FIGS. 7A, 7B).

In these last two embodiments of the torsion spring 4 with two helicoidal winding bodies 7, the central joining portion 9 and the arms 8 are positioned at the same side relative to the spring axis 12. In these last two embodiments, a positioning sphere 10 can also be placed, which in this case would be disposed on the central joining portion 9, or it can even be disposed in the cavity of a central positioning element 6, cylindrical, semi-cylindrical or semi-spherical.

In another embodiment, both the central joining portion 9 and the arms 8 are arranged at opposite sides relative to the spring axis 12 (see FIGS. 8A, 8B, 9). In this case, the central joining portion 9 and the arms 8 have a seat in the casing 3 and exert tension towards the synchronizer hub 2, while the winding bodies 7 exert tension towards the clutch sleeve 1 via the cap 15 and/or its positioning element 6.

With respect to the last mentioned embodiment, the central joining portion 9 and the arms 8 alternatively can be arranged within the casing 3 such, that they can exert tension towards the clutch sleeve 1 via the cap 15 and/or its positioning element 6, while the winding bodies 7 exert tension towards the synchronizer hub 2.

With respect to the embodiments according to FIGS. 8A, 8B and 9, a pin 19 (preferably acting as a shaft) is positioned within an inner space 20 of the winding bodies 7. The pin 19 is able to transmit the spring force by pressing in the inner area of the coils 13 during the movement of the torsion spring 4 along a transverse direction 14. By providing a contact area at the inner surface of the coils 13, that creates the tension in the spring, it is possible to avoid direct contact at the outer surface of the coils 13 and therefore to avoid stress concentrations in the torsion spring 4 and eventually subsequent breakage of coils 13.

As can be seen in FIGS. 8A-10, the cap 15 can have different shapes. In each case, the cap 15 contains two axial opposite positioned side flanges 21. In a mounted position, these side flanges 21 flank between them the torsion spring 4. According to FIGS. 8A, 8B and 9, each of the side flanges 21 has a hole for mounting the pin 19. According to FIG. 10, the function of the pin 19 is substituted by a contact flange 23 as a part of the cap 15. This contact flange 23 is general semi-cylindrical shaped. At one axial end portion of contact flange 23, there is a bending zone 24 between the contact flange 23 and the adjacent portion of the cap 15. This bending zone 24 allows a bending of the contact flange 23 for mounting and position the torsion spring 4 between the two side flanges 21. In the mounting state of the torsion spring 4, the contact flange 23 is arranged within the inner space 20 of the torsion spring 4.

1. A synchronism system for a vehicle power transmission mechanism, the synchronism system comprising:
a locking device having at least one elastic element and a casing for housing therein said at least one elastic element, said locking device contacting elastically with a sliding clutch sleeve of the power transmission mechanism and a synchronizer hub of the power transmission mechanism, said at least one elastic element being a torsion spring, exerting tension towards the sliding clutch sleeve and towards the synchronizer hub.

2. The synchronism system according to claim 1, wherein said torsion spring has a spring axis and a spring force directed in a transverse direction to said spring axis.

3. The synchronism system according to claim 1, wherein said casing of said locking device is part of the synchronizer hub.

4. The synchronism system according to claim 1, further comprising a housing and said casing is disposed in said housing made in a periphery of the synchronizer hub.

5. The synchronism system according to claim 1, wherein said locking device has a positioning element housed in said casing, said positioning element is in contact with said torsion spring and contacts with the sliding clutch sleeve, said torsion spring exerts tension towards the sliding clutch sleeve through said positioning element.

6. The synchronism system according to claim 5, wherein said positioning element is housed in said casing and protrudes at least partially from said casing.

7. The synchronism system according to claim 6, wherein said positioning element has a plate with a protuberance which partially protrudes from said casing.

8. The synchronism system according to claim 5, wherein said positioning element is housed in said casing and protruding at least partially from said casing and has a cavity formed therein for housing therein at least part of said torsion spring.

9. The synchronism system according to claim 5, wherein said positioning element has a geometry selected from the group consisting of a part-spherical geometry, a semi-spherical geometry, a spherical geometry, a part-cylindrical geometry, a semi-cylindrical geometry and a cylindrical geometry.

10. The synchronism system according to claim 5, wherein said torsion spring exerts tension towards the synchronizer hub through said casing.

11. The synchronism system according to claim 5, wherein said torsion spring has at least one helicoidal winding body with a pair of end arms.

12. The synchronism system according to claim 11, wherein said helicoidal winding body rests on said pair of arms, whereby said helicoidal winding body exerts tension towards the sliding clutch sleeve and said pair of arms exert tension towards the synchronizer hub.

13. The synchronism system according to claim 11, wherein said locking device contains a seat within said casing, said helicoidal winding body is disposed, whereby a first of said pair of end arms exerts tension towards the sliding clutch sleeve and a second of said pair of end arms exerts tension towards the synchronizer hub.

14. The synchronism system according to claim 11, wherein said torsion spring has two helicoidal winding bodies joined together by a central joining portion and contains one of said pair of end arms at each one of said helicoidal winding bodies.

15. The synchronism system according to claim 14, wherein said central joining portion exerts tension towards the sliding clutch sleeve and said pair of end arms exert tension towards the synchronizer hub.

16. The synchronism system according to claim 14, wherein said central joining portion exerts tension towards the synchronizer hub and said pair of end arms exert tension towards the sliding clutch sleeve.

17. The synchronism system according to claim 14, wherein at least one of said central joining portion and said pair of end arms exert tension towards the synchronizer hub or towards the sliding clutch sleeve and said helicoidal winding bodies exert tension towards the sliding clutch sleeve or towards the synchronizer hub.

18. The synchronism system according to claim 11, wherein said locking device has a pin positioned within said at least one helicoidal winding body.

19. The synchronism system according to claim 18, wherein said pin is joined with said positioning element.
